(19) United States
(12) Patent Application Publication
(10) Pub. No.: US 2010/0077240 A1
(43) Pub. Date: Mar. 25, 2010

(54) METHODS AND APPARATUSES FOR REDUCING POWER CONSUMPTION OF FULLY-BUFFERED DUAL INLINE MEMORY MODULES

(75) Inventors: Bharat K. Daga, Framont, CA (US); Thomas Martin Wicki, Palo Alto, CA (US)

Correspondence Address: DORSEY & Whitney LLP;on behalf of Sun Microsystems, Inc., 370 SEVENTEENTH ST., SUITE 4700, DENVER, CO, 80202-5647, US

(73) Assignee: Sun Microsystems, Inc., Santa Clara, CA (US)

(21) Appl. No.: 12/235,471

(22) Filed: Sep. 22, 2008

(51) Int. Cl. G06F 1/32; G06F 12/00

(52) U.S. Cl. 713/320; 711/166; 711/E12.001

(57) ABSTRACT

Methods and apparatuses are presented for reducing the power consumed in an in-line memory module. In some embodiments, the method may include monitoring a memory requirement of a computer system, the computer system comprising a plurality of memory modules. In the event that the memory requirement changes, unmapping at least one of the plurality of memory modules and maintaining a low power state for the at least one unmapped memory module. The method may further comprise selectively re-initializing the plurality of memory modules such that the at least one unmapped memory module remains in a low power state while the remainder of the plurality of memory modules are in a non-low power state. Where, in the event that the memory requirement changes again, the method also may comprise re-programming the memory controller with an identifier associated with the at least one unmapped memory module.

### BACKGROUND

Computers are ubiquitous in today's society. They come in all different varieties and can be found in places such as automobiles, the grocery store, banks, personal digital assistants, cell phones, as well as in many businesses. As will be appreciated by almost anyone owning a computer, there is a trend of incorporating more and more functionality into the same amount of space. This trend may be due to many factors, such as, the miniaturization and increasing density of system components with each successive generation of computer. These increases in system density in successive generations of computers may cause the computer to consume greater amounts of power than their predecessors and/or operate at higher temperatures and require greater amounts of power to cool the computer than their predecessors.

Computers utilizing Fully Buffered Dual In-line Memory Modules (FB-DIMMs) may be especially susceptible when it comes to power consumption and higher operating temperatures. In general, FB-DIMMs are an industry standard memory scheme that organizes a plurality of dynamic random access memory (DRAM) chips as a memory, where the processor and the memory communicate via a high speed serialized link. The power consumption and heat generation of a memory circuit is generally proportional to its data rate, and therefore, increasing the data rate increases the power consumption and heat generated by a memory circuit. Since FB-DIMM type memory often operate at increased data rates as compared to non-FB-DIMMs, FB-DIMMs generally consume more power and generate more heat than non-FB-DIMM memory. In fact, FB-DIMM memory power consumption may be the largest source of power consumption in some enterprise computing systems. Thus, methods and apparatuses are needed that reduce the power consumption of FB-DIMM memory computing systems.

### SUMMARY

Methods and apparatuses are presented for reducing the power consumed in an in-line memory module. In some embodiments, the method may include monitoring a memory requirement of a computer system, the computer system comprising a plurality of memory modules. In the event that the memory requirement changes, unmapping at least one of the plurality of memory modules and maintaining a low power state for the at least one unmapped memory module. The method may further comprise selectively re-initializing the plurality of memory modules such that the at least one unmapped memory module remains in a low power state while the remainder of the plurality of memory modules are in a non-low power state. Where, in the event that the memory requirement changes again, the method also may comprise re-programming the memory controller with an identifier associated with the at least one unmapped memory module.

Some embodiments may include a computer system, the computer system may include: a central processing unit (CPU), a memory controller coupled to the CPU, and a plurality of memory modules serially coupled to the memory controller. Each memory module may include at least two memory chips and a buffer coupled to the at least two memory chips. In the event the computer system is in a low power state, the memory controller may be programmed such that at least one of the plurality of memory modules is unaddressable by the computer system.

Other embodiments may include a tangible storage medium with instructions stored thereon. The instructions stored on the tangible medium may include monitoring a memory requirement of the computer system, the computer system comprising a plurality of memory modules. In the event that the memory requirement changes, the instructions may unmap at least one of the plurality of memory modules and maintain a low power state for the at least one unmapped memory module. The instructions may further comprise the act of selectively re-initializing the plurality of memory modules such that the at least one unmapped memory module may remain in a low power state while the remainder of the plurality of memory modules are in a non-low power state.

### BRIEF DESCRIPTION OF THE DRAWINGS

For a detailed description of the various embodiments of the invention, reference will now be made to the accompanying drawings, in which:

FIG. 1 illustrates an exemplary computer system;

FIG. 2 represents an exemplary memory module configuration; and

FIG. 3 illustrates an exemplary method for reducing power consumption.

The use of the same reference symbols in different drawings indicates similar or identical items.

### DETAILED DESCRIPTION

In some embodiments, methods and apparatuses may be provided that allow the fully-buffered dual inline memory modules (FB-DIMMs) to be controlled such that the FB-DIMMs consume less power. FB-DIMMs may be used in all types of computers and may find particular relevance within enterprise computing systems. The methods of operating the FB-DIMMs may include determining that a low power state of the computing system is desired during operation. A low power state may be desired, for example, as the computing requirements change throughout the day. In the event that a low power state is desired, the computing system may render a portion of the FB-DIMMs inaccessible. Exemplary methods of rendering a portion of the FB-DIMMs inaccessible may include unmapping them from the computing systems memory map and selectively re-initializing when the FB-DIMMs are re-initialized per the FB-DIMM industry specification.

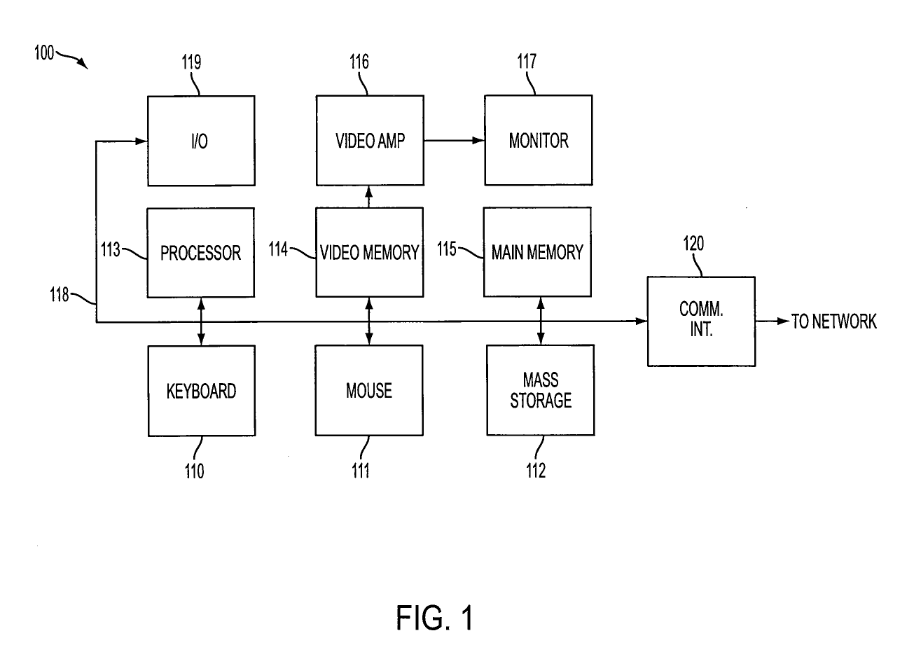

Referring to computer system 100 shown in FIG. 1. In some embodiments, the computer system 100 may be an implementation of enterprise level computers, such as one or more blade-type servers within an enterprise. In other embodiments, the computer system 100 may be a personal computer and/or a handheld electronic device. A keyboard 110 and mouse 111 may be coupled to the computer system 100 via a system bus 118. The keyboard 110 and mouse 111, in one example, may introduce user input to computer system 100 and communicate that user input to a processor 113. Other suitable input devices may be used in addition to, or in place of, mouse 111 and keyboard 110. An input/output unit 119 (I/O) coupled to system bus 118 represents such I/O elements as a printer, audio/video (A/V) I/O, etc.

Computer system 100 also may include a video memory 114, a main memory 115 and a mass storage 112, all coupled to system bus 118 along with keyboard 110, mouse 111 and processor 113. Mass storage 112 may include both fixed and removable media, such as magnetic, optical or magnetic optical storage systems and any other available mass storage technology. Bus 118 may contain, for example, address lines for addressing video memory 114 or main memory 115. System bus 118 also includes, for example, a data bus for transferring data between and among the components, such as processor 113, main memory 115, video memory 114 and mass storage 112. Video memory 114 may be a dual-ported video random access memory. One port of video memory 114, in one example, is coupled to video amplifier 116, which is used to drive a monitor 117. Monitor 117 may be any type of monitor suitable for displaying graphic images, such as a cathode ray tube monitor (CRT), flat panel, or liquid crystal display (LCD) monitor or any other suitable data presentation device.

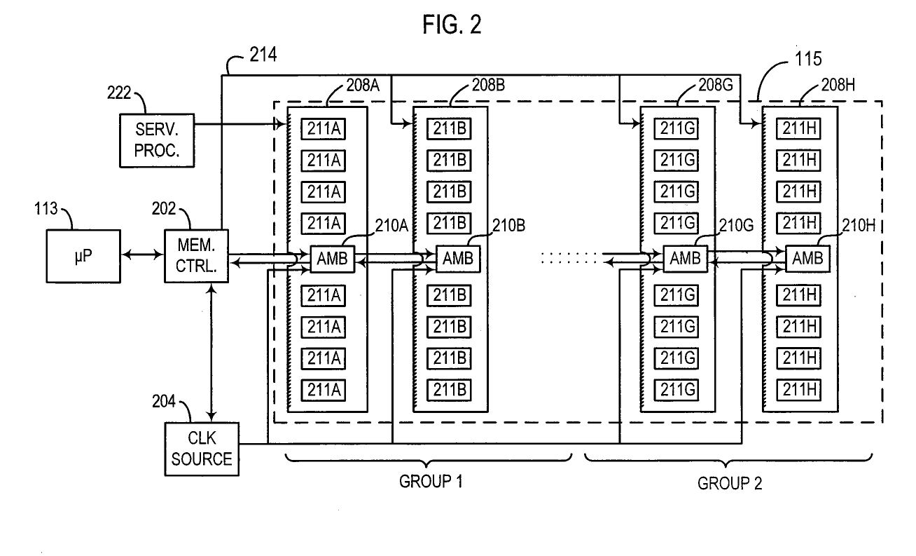

In some embodiments, processor 113 is a SPARC® microprocessor from Sun Microsystems, Inc., or a microprocessor manufactured by Motorola, such as the 680XX0 processor, or a microprocessor manufactured by Intel, such as the 80×86, or Pentium® processor. Any other suitable microprocessor or microcomputer may be utilized, however. In some embodiments, the main memory 115 is a set of FB-DIMMs that communicate serially with other system components as described in more detail below with regard to FIG. 2.

Computer system 100 also may include a communication interface 120 coupled to bus 118. Communication interface 120 provides a two-way data communication coupling via a network link. For example, communication interface 120 may be a local area network (LAN) card, or a cable modem, and/or wireless interface. In any such implementation, communication interface 120 sends and receives electrical, electromagnetic or optical signals which carry digital data streams representing various types of information.

Code received by computer system 100 may be executed by processor 113 as it is received, and/or stored in mass storage 112, or other non-volatile storage for later execution. In this manner, computer system 100 may obtain code in a variety of forms. For example, the code received and/or stored may be application code or code related to an operating system (OS) to be executed on the computer system 100. Regardless of the type of code (e.g., application or OS), it may be embodied in any form of computer program product such as a medium configured to store or transport computer readable code or data, or in which computer readable code or data may be embedded. Examples of computer program products include CD-ROM discs, ROM cards, floppy disks, magnetic tapes, computer hard drives, servers on a network, and solid state memory devices. As will be described in more detail below, the OS code executing on the computer system 100 may allocate the memory 115 into one or more logical groups.

FIG. 2 depicts the computer system 100 employing an exemplary memory 115 as FB-DIMMs. As shown, the computer system 100 may include a memory controller 202 coupled between the processor 113 and the memory 115. The memory controller 202 may be integrated within the processor 113, or in some embodiments, may exist as a separate component within the computer system 100. During operation, the memory controller 202 may receive signals from the processor 113 that are to be stored in the memory 115. The signals from the processor 113 may take place as parallel data communication. Since the memory 115 implements FB-DIMMs, the memory controller 202 may communicate data to the memory 115 in serial form, and accordingly the memory controller 202 may be capable of serializing data received from the processor 113.

The computer system 100 also may include a clock source 204 coupled to the memory controller 202 and the memory 115. The clock source 204 may provide a signal to the memory 115 and the memory controller 202 such that they operate in synchronous fashion. In other embodiments, the clock source 204 may provide a timing signal that is asynchronous to the operation of the memory 115 and/or the memory controller 202.

The clock source 204 may take a variety of physical forms, including in some embodiments, a crystal based oscillator with relatively low phase noise and/or clock jitter. In other embodiments, the clock source 204 may be a frequency synthesized signal based on a crystal oscillator signal, such as a phase locked loop (PLL) synthesizer.

As shown in FIG. 2, the memory 115 may include one or more FB-DIMMs 208A-H. While eight FB-DIMMs are illustrated as an exemplary configuration, it should be appreciated that any number of FB-DIMMs are possible. In fact, one of the advantages of using FB-DIMMs, as opposed to double-data-rate (DDR) memory, is that many more DIMMs are possible with FB-DIMMs thereby allowing storage capacity to be expanded over other technologies, such as DDR. In the embodiments where the computer system 100 is a server, the ability to expand capacity in this manner may be particularly desirable. Furthermore, the latency related to parallel bus loaded memory architectures (such as DDR) may be eliminated by using serial data communication techniques to communicate between the memory controller 202 and the memory 115.

Each FB-DIMM 208A-H may include at least one advanced memory buffer (AMB) 210A-H respectively. The AMB 210A may be serially coupled to the memory controller 202 on the “downstream” channel (i.e., the channel of the FB-DIMM proceeding away from the memory controller 202) and also may be serially coupled to the AMB 210B of the next FB-DIMM 208B on the “upstream” channel (i.e., the channel of the FB-DIMM proceeding toward the memory controller 202). Note that other channels, besides upstream and/or downstream, are possible. In the event data is written to the memory 115 or a command is passed to the memory 115, each AMB 210A-H may receive this data from the upstream channel of the FB-DIMM and pass this data serially to other FB-DIMMs that are downstream in a daisy-chain fashion until the intended AMB 210A-H is found. Similarly, in the event that data is read from the memory 115, each AMB 210A-H may receive data from the downstream channel of the FB-DIMM and pass this data serially to other FB-DIMMs that are upstream in a daisy-chain fashion until the data reaches the memory controller 202. In some embodiments, the FB-DIMMs may communicate with the memory controller using differential serial pairs or lanes that are separate for the upstream and downstream channels. For example, in some embodiments, there may be 10 downstream lanes and 14 upstream lanes.

In some embodiments, the memory 115 may be operated in “gang” mode along the FB-DIMM channels. Briefly, gang mode allows portions of a memory request to be satisfied using multiple that run in the same direction. In other words, gang mode may include operating two or more downstream channels or two or more upstream channels simultaneously. Thus, in the event that the computer system 100 caches information to and/or from the memory 115, a cache line may be satisfied in whole or in part from the upstream channel and/or the downstream channel.

Memory reads and writes may occur independent of each other because the upstream and downstream channels are separate. Upstream communications from the FB-DIMMs 208A-H to the memory controller 202, such a memory read, may occur separate from downstream communications from the memory controller 202 to the FB-DIMMs 208A-H, such as a memory write and/or commands.

Each FB-DIMM 208A-H also may include a plurality of individual memory chips 211A-H, where the individual memory chips 211A-H associated with a particular FB-DIMM 208A-H may be collectively or individually addressed by the memory controller 202. Although eight memory chips 211A-H are shown in FIG. 2, in some embodiments, the number of individual memory chips 211A-H per FB-DIMM 208A-H may be nine. Additionally, the individual memory chips 211A-H may be memory chips of the type used in non-FB-DIMM type systems, such as DDR or DDR2 dynamic random access memory (DRAM) chips. Since these chips 211A-H may be of the type used in non-FB-DIMM type systems, they may be configured to receive their data in parallel fashion. The AMB 210A-H therefore may be responsible for taking serial data communications from the memory controller 202, buffering this data, and passing it along to the individual memory chips 211A-H in a parallel fashion. Because the AMBs 210A-H may be responsible for buffering and/or distributing serial communication in a parallel fashion, the AMBs 210 A-H may operate at much higher data rates and/or temperatures than other portions of the FB-DIMMs 208A-H.

As was mentioned above, the OS running on the computer system 100 may allocate the memory 115 into logically separate groups. In some embodiments, this may be accomplished by organizing some of the FB-DIMMs 208A-H into logical groups that may be separately addressed by the memory controller 202. For example, if the total number of FB-DIMMs 208A-H is eight, then some embodiments may logically organize the eight FB-DIMMs 208A-H into two logically separate groups of four FB-DIMMs within each group, e.g., FB-DIMMs 208A-D in GROUP 1 and FB-DIMMs 208E-H in GROUP 2. This may be referred to as a 2×4 grouping and is illustrated in FIG. 2. In this example, each group may be separately addressed by the memory controller 202, and appear to the OS running on the computer as separately addressable memory spaces. Other grouping examples include organizing each FB-DIMM 208A-H into a separate logical group itself, e.g., an 8×1 grouping if there are eight total FB-DIMMs. Although exemplary grouping configurations are shown in the figures and discussed herein, this discussion is merely exemplary and should not be interpreted as the only possible grouping configuration or that grouping is required.

During operation, the memory controller 202 may address any of the FB-DIMMs 208A-H by designating one or more bits in the memory storage address that is conveyed from the memory controller 202 to the series chain of AMBs 210A-H. For example, in the 2×4 grouping example shown in FIG. 2, a first bit in the data address from the memory controller 202 may indicate that the data is to be stored in GROUP 1, i.e., stored in one of the FB-DIMMs 208A through 208D. A portion of the data address in this example then may indicate the particular AMB 210A-D where the data is stored.

In some embodiments, data from the computer system 100 may be stored in the memory 115 such that it is interleaved within the FB-DIMMs 208A-H of each group. In other words, if the computer system 100 is caching data to the memory 115, each consecutive cache line may be stored to a different FB-DIMM 208A-H within the same group.

In some embodiments, one or more of the FB-DIMMs 208A-H may go unused by the computer system 100. For example, if the computer system 100 is a web server it may be idle for long period of time in the evening, and therefore, the computer system 100 may not be using as much memory 115 as it would during peak operation times. When the computer system 100 is using less of the memory 115, one or more of the FB-DIMMs 208A-H may be put in a low power state to reduce the overall power consumption of the computer system 100 while retaining data that may have been cached into the particular FB-DIMM.

The selection of which FB-DIMMs are put in a low power state may vary between embodiments. In some embodiments, the selection may be random. In other embodiments, since the FB-DIMMs 208A-H are serially connected through the AMBs 210A-H and since data travels serially from the first AMB 210A through subsequent AMBs 210B-G prior reaching the last AMB 210H, the one or more FB-DIMMs furthest away from the memory controller 202 may be selectively put in a low power state to reduce the overall power consumption. In this situation, a reduction in power state may be effectuated without interrupting access to FB-DIMMs that are located closer to the memory controller 202. In other embodiments, such as when access to the memory 115 is interleaved, groups of FB-DIMMs 208A-H, such as GROUP 2 may be separately put in a low power state while GROUP 1 remains fully powered up.

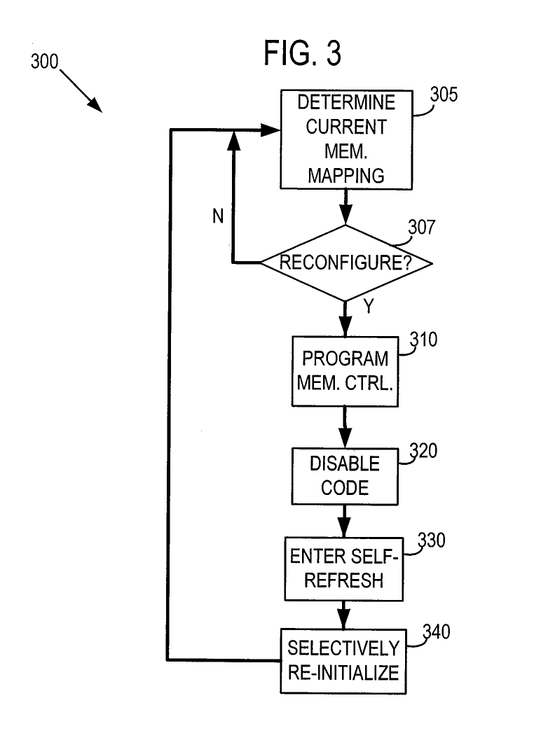

FIG. 3 illustrates exemplary operations 300 for selectively controlling the power state of some FB-DIMMs 208A-H while maintaining the power state of other FB-DIMMs 208A-H. Depending upon the particular embodiment, the operations 300 may be performed autonomously by the computer system 100 or may be performed in response to a measured condition, such as the computer system 100 determining that its power consumption exceeds a predetermined level. As shown in operation 305, the computer system 100 may determine the current memory mapping of the various FB-DIMMs 208 A-H. This may include determining the grouping of the FB-DIMMs 208A-H. In some embodiments, the operations 300 may be performed by the OS and/or by application software executing on the computer system 100.

In other embodiments, the operations 300 may be performed solely by hardware within the computer system 100. For example, an application specific integrated circuit (ASIC), not specifically shown in the figures, may control the power state without regard to software executing on the computer system 100. In this example, the ASIC may implement power savings features at a particular time of the day without regard to software executing on the computer system 100.

In operation 307, the computer system 100 may determine if reconfiguration of the power state of the various FB-DIMMs 208A-H is desired. Reconfiguration of the memory 115 may be due to a variety of reasons. For example, the memory may be reconfigured from a low power state when the computer system 100 needs additional memory space notwithstanding the consequent increase in power consumption. Alternatively, in some embodiments, the memory controller 202 may be programmed such that it takes notice when the OS unmaps memory, and then the memory controller 202 may autonomously reconfigure the FB-DIMMs 208 A-H to reflect this unmapping. As mentioned above, this may occur at different times of the day when the computer system 100 experiences greater processing activity and/or memory storage requirements. In the event that the computer system 100 determines that reconfiguration is not desired, control may flow from operation 307 back to operation 305, where the current memory mapping may be determined.

In the event that reconfiguration is desired, control may flow to operation 310 where the memory controller 202 may be programmed to check that the FB-DIMMs that are to be put in a low power state are no longer addressable. As mentioned above, in some embodiments, the FB-DIMMs to be unmapped from the OS and are no longer addressable may be FB-DIMMs that are the furthest away from the memory controller 202. Once the FB-DIMMs have been unmapped by the OS, the memory controller 202 may be programmed to reflect the desired AMB in the serial chain of the AMBs 210A-H. In some embodiments, this may include programming the memory controller 202 with a different AMB identifier to indicate the last addressable FB-DIMM of the memory channel. For example, if the last two FB-DIMMs 208G-H have been unmapped and are to be non-addressable to conserve the amount of power they consume, then the FB-DIMM 208F may be set as the last addressable FB-DIMM in the memory range by re-programming the address of the AMB 210F as the last addressable value. In this manner, the FB-DIMMs 208G-H may no longer be addressed by the memory controller 202.

It should be noted that when the groups of FB-DIMMs are accessed to in an interleaved fashion, then all the FB-DIMMs within the interleaved group (e.g., GROUP 1 or GROUP2) may be required to enter a low power state at the same time.

It should also be noted that the memory controller 202 may autonomously reprogram itself after monitoring the mapping by the OS. For example, the memory controller 202 may reprogram itself periodically as the OS changes the memory mapping.

Once the memory controller 202 has been reprogrammed, in operation 320, a FB-DIMM “disable code” may be issued according to the Joint Electronic Devices Engineering Council (JEDEC) memory specification. Briefly, the disable code is a low power signal, per the JEDEC specification, that instructs the memory 115 to enter a low power state. When the disable code is asserted, the individual memory chips 211A-H each enter a self-refresh state, as shown in operation 330. This self-refresh state is the lowest possible power state for the individual memory chips 211A-H where the contents of the individual memory chips 211A-H are preserved. The actual amount of power consumed by the individual memory chips 211A-H during this state may vary between manufacturers. Continued assertion of the disable code (per operation 320) for a predetermined period of time after the individual memory chips 211A-H enter their lowest power state may result in the AMBs 210A-H entering their lowest power state.

Referring momentarily back to FIG. 2, the computer system 100 may further include a service processor 222 coupled to the FB-DIMMs 208A-H. In some embodiments, the service processor 222 may be coupled to the FB-DIMMs 208A-H and the memory controller 202 via a low frequency bus 214. In other embodiments, the service processor may couple to the FB-DIMMs 208A-H and the memory controller 202 via the upstream and/or downstream channels. During operation, when the memory controller 202 determines a bit error has occurred, it may perform a re-initialization of the upstream and/or downstream communication channels. This re-initialization is part of the JEDEC specification.

Referring again to FIG. 3, once the memory 115 has been given the disable code and the FB-DIMMs are in a low power state (per operations 305-330) certain FB-DIMMs may remain in a low power state while the rest of the FB-DIMMs continue to be re-initialized selectively per operation 340. For example, if the last two unmapped FB-DIMMs 208G-H are designated to be in a low power state, then the remaining mapped FB-DIMMs 208A-F may be re-initialized normally while the last two FB-DIMMs 208G-H are not re-initialized. This selective re-initialization of a portion of the FB-DIMMs 208A-H leaves the FB-DIMMs 208G-H in an “offline” state where they consume less power than they would during normal operation. It is believed that a 20% savings is possible between when the FB-DIMMs are mapped and in the idle condition—i.e., where the FB-DIMM is capable of being accessed (mapped), but is not being accessed—and when half of them have been unmapped and are in a low power state (after operation 340). Furthermore, it is believed that alternative configurations may provide greater power savings.

In some embodiments, the memory 115 may remain in this low power state until the memory requirements of the computer system 100 have changed. In the event that the computer system 100 determines that reconfiguration is desired, control may flow from operation 340 back to operation 305, where the current memory mapping may be determined and the memory 115 may be reconfigured as necessary per operation 307.

Upon re-entering operation 305, if the memory 115 is coming from a low power state, at least some of the FB-DIMMs 208A-H may be unmapped. In this situation, the memory controller 202 may be re-programmed to enable one or more of these offline FB-DIMMs by programming the particular AMB identifier in the memory controller 202. For example, the FB-DIMMs 208E-H are in a low power state, then the operation 310 may bring them back online by reconfiguring the memory controller 202 such that the last FB-DIMM that is addressable by the memory controller 202 is the AMB 210H instead of the AMB 210D. Once the memory controller 202 has been re-programmed, per operation 310, operations 320-340 continue in the same fashion as described above except that certain FB-DIMMs 208A-H may be brought back online. Bringing the FB-DIMMs 208A-H back online may include re-programming the memory controller 202 such that the selected AMBs that were initially offline resume full power and may be addressed. For example, this may occur if the memory controller 202 de-asserts the disable code signal as part of operation 340. Also, if the disable code signal is de-asserted, the individual memory chips 211 A-H may exit the self-refresh state such that the FB-DIMMs 208A-H resume full power and may not be initialized by operation 340.

The above discussion is meant to be illustrative of the principles and various embodiments of the present invention. Numerous variations and modifications will become apparent once the above disclosure is fully appreciated. For example, although the disclosure discusses reconfiguring which FB-DIMMs 208A-H in peak and non-peak times of activity coinciding with daytime and nighttime loads on the computer system 100, the determination as to whether to reconfigure the FB-DIMMs may occur on a periodic basis at any variety of times. That is, in some embodiments, the memory 115 may be reconfigured anywhere from several times per hour to several times per day. The claims should be interpreted to include any and all such variations and modifications. In addition, the above description has broad application, and the discussion of any embodiment is meant only to be exemplary, and is not intended to intimate that the scope of the disclosure, including the claims, is limited to these embodiments.

We claim:

1. A method of operating a computer system, the method comprising the acts of:
monitoring a memory requirement of the computer system, the computer system comprising a plurality of memory modules;
in the event that the memory requirement changes, unmapping at least one of the plurality of memory modules and maintaining a low power state for the at least one unmapped memory module;
selectively re-initializing the plurality of memory modules such that the at least one unmapped memory module remains in a low power state while the remainder of the plurality of memory modules are in a non-low power state.

2. The method of claim 1, further comprising the act of segregating the plurality of memory modules into a first group and a second group, the second group including the at least one unmapped memory module, and wherein the act of unmapping the at least one unmapped memory module includes the act of programming a memory controller with an address associated with the first group.

3. The method of claim 2, in the event that the memory requirements change again, re-initializing the plurality of memory modules such that the second group operates at a non-low power state.

4. The method of claim 3, wherein the plurality of memory modules comprise individual memory chips coupled to a serial buffer and the low power state corresponds to a condition where the individual memory chips are in a self-refresh state and the serial buffer is in its lowest power state without powering off.

5. The method of claim 2, in the event that the memory requirements change, the method further comprises the act of re-programming the memory controller with an identifier associated with the second group.

6. The method of claim 1, wherein each of the plurality of memory modules are coupled together via one or more serial buffers, and wherein the act of unmapping the at least one unmapped memory module includes the act of reprogramming a memory controller with an address associated with the one or more serial buffers that is located closer to the memory controller.

7. The method of claim 5, wherein the plurality of memory modules comprise fully buffered dual in-line memory modules (FB-DIMMs).

8. The method of claim 5, wherein the memory modules in the first group are not in a self-refresh mode and the memory modules in the second group are in a self-refresh mode.

9. The method of claim 1, wherein the act of maintaining an idle condition includes issuing a disable code to the plurality of memory modules.

10. The method of claim 1, wherein the plurality of memory modules are serially connected.

11. A computer system comprising:
a central processing unit (CPU);
a memory controller coupled to the CPU; and
a plurality of memory modules coupled to the memory controller, each memory module comprising:
at least two memory chips;
one or more buffers coupled to the at least two memory chips; and
wherein, in the event the computer system is in a low power state, the memory controller is programmed such that at least one of the plurality of memory modules is unaddressable by the computer system.

12. The computer system of claim 11, wherein the memory controller is programmed with an identifier associated with a buffer associated with at least one of the plurality of memory modules that is addressable by the computer system.

13. The computer system of claim 11, wherein the at least one unaddressable memory module is located farther away from the memory controller than the remainder of the plurality of memory modules.

14. The computer system of claim 11, wherein only the remainder of the plurality of memory modules are addressable.

15. The computer system of claim 14, wherein, in the low power state, the at least two memory chips in the at least one unaddressable memory module are in a self-refresh state while the at least two memory chips in the remainder of the plurality of memory modules are not in a self-refresh state.

16. The computer system of claim 15, wherein, in the event the computer system is entering a non-low power state, all of the memory modules within the plurality are re-initialized such that none of the at least two memory chips are in a self-refresh state.

17. The computer system of claim 11, wherein the plurality of memory modules are serially coupled together.

18. A tangible storage medium comprising instructions, the instructions comprising the acts of:
monitoring a memory requirement of the computer system, the computer system comprising a plurality of memory modules;
in the event that the memory requirement changes, unmapping at least one of the plurality of memory modules and maintaining a low power state for the at least one unmapped memory module;
selectively re-initializing the plurality of memory modules such that the at least one unmapped memory module remains in a low power state while the remainder of the plurality of memory modules are in a non-low power state.

19. The tangible storage medium of claim 18, the instructions further comprising the act of programming a memory controller with an identifier associated with a buffer associated with at least one of the plurality of memory modules that is addressable by the computer system.

20. The computer system of claim 18, in the event that the memory requirements change again, re-programming the memory controller with an identifier associated with the at least one unmapped memory module.
